(19) United States
(12) Patent Application Publication
(10) Pub. No.: US 2004/0230451 A1
(43) Pub. Date: Nov. 18, 2004

(54) System and method for locating flights and air fares

(76) Inventor: Romek Figa, Hanover, MA (US)

Correspondence Address: Richard M. Lehrer, Esq., Mintz, Levin, Cohn, Ferris, Glovsky & Popeo, P.C., The Chrysler Center, 666 Third Avenue, 24th Floor, New York, NY, 10017, US

(21) Appl. No.: 10/846,812

(22) Filed: May 14, 2004

Related U.S. Application Data
(60) Provisional application No. 60/471,186, filed on May 16, 2003.

(51) Int. Cl. G06F 17/60

(52) U.S. Cl. 705/1; 705/5

(57) ABSTRACT

The present invention provides a network-based system and method for determining airfares based upon origin and destination, and for searching the resulting airfares by date and cost. The results are provided in a calendar format with the lowest fares for each day displayed in the calendar. Also a list of all fares available for a particular day are displayed with the calendar.

This application claims benefit under 35 U.S.C. § 119(e) of U.S. Provisional Application No. 60/471,186, filed May 16, 2003, the entire disclosure of which is herein incorporated by reference.

### BACKGROUND OF THE INVENTION

### FIELD OF THE INVENTION

The invention relates generally to air travel services and more particularly to a system and method for locating airfares and dates for which the fares are valid.

Various Internet travel services, such as Orbitz™, Yahoo travel™, Travelocity™, Cheaptickets™, Hotwire™, Expedia™, Travel™, Biztravel™, Lycos travel™, Excite travel™ and others, are available for locating and booking plane reservations. With the exception of Travelocity™ an operator must enter not only the origin and destination but the date of travel as well (Orbitz™ allows a little flexibility but still requires the operator to at least enter a month). With these types of systems it makes it very time consuming, especially if the operator has a dial-up connection, to find the cheapest flight. It also makes it difficult if the operator does not know the exact dates of desired travel. While Travelocity™ provides the operator with an option that the dates are not important the results are difficult to search because they are provided in a scrollable list in ascending price order with the dates in small print. Accordingly, if the operator wishes to search by date it is very difficult.

Accordingly, there exists a need for a computer travel service which enables the operator of the service to search fares without the need to enter dates of travel and which displays the results in manner that enables the operator to easily compare fares on different dates.

### SUMMARY OF THE INVENTION

Many advantages of the present invention will be determined and are attained by the present invention, which in one aspect provides a method of locating airfares. The method includes receiving a starting location and an ending location in a search engine. The search engine determines flights scheduled to fly between the starting location and the ending location during a predetermined time period. The search engine also determines a cost for each of the determined flights. Finally, the method includes displaying at least one of the costs in a calendar, wherein the calendar includes at least a portion of the predetermined time period.

Another aspect of the invention provides a system for locating airfares. The system includes a computer, accessible from at lease one remote location, configured to display a starting location field and a destination field. After the fields are populated, the computer is configured to locate flights scheduled to fly between the starting location and the ending location during a predetermined time period. The computer is also configured to determine a cost for each of the determined flights and to display at least one of the costs in a calendar. The calendar includes at least a portion of the predetermined time period.

The invention will next be described in connection with certain illustrated embodiments and practices. However, it will be clear to those skilled in the art that various modifications, additions and subtractions can be made without departing from the spirit or scope of the claims.

### BRIEF DESCRIPTION OF THE SEVERAL VIEWS OF THE DRAWINGS

For a fuller understanding of the nature and objects of the invention, reference should be made to the following detailed description and accompanying drawings, in which:

FIG. 1 illustrates a sample start screen in accordance with an embodiment of the invention showing the From and To boxes filled in;

FIG. 2 illustrates a sample result screen for the information filled in the embodiment of FIG. 1;

FIG. 3 illustrates another sample start screen in accordance with an embodiment of the invention showing the From and To boxes filled in with different information;

FIG. 4 illustrates a sample result screen for the information filled in the embodiment of FIG. 3;

FIG. 5 illustrates another sample start screen in accordance with an embodiment of the invention showing the From and To boxes filled in with still different information;

FIG. 6 illustrates a sample result screen for the information filled in the embodiment of FIG. 5;

FIG. 7 illustrates a sample result screen for a feature of the present invention.

FIG. 8 is a block diagram of the system of the present invention.

### DETAILED DESCRIPTION OF THE INVENTION

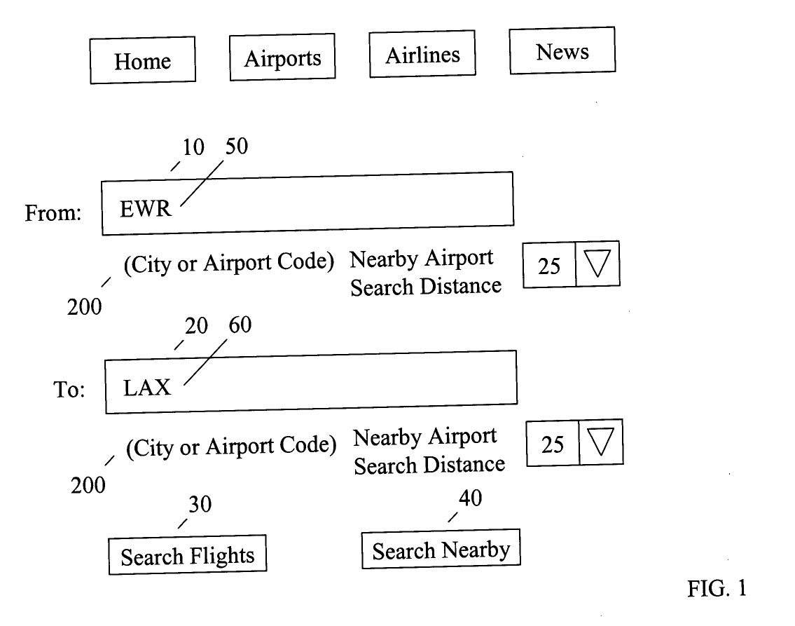

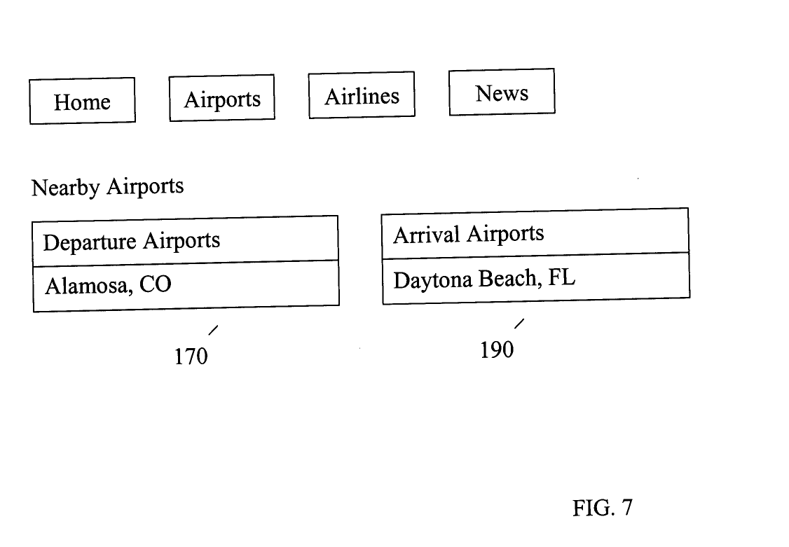

The present invention provides a system and method for determining travel fares based upon origin and destination, and for searching the resulting fares by date. Referring to the drawings in detail wherein like reference numerals identify like elements throughout the various figures, there is illustrated in FIGS. 1 to 7 a system and method according to the invention.

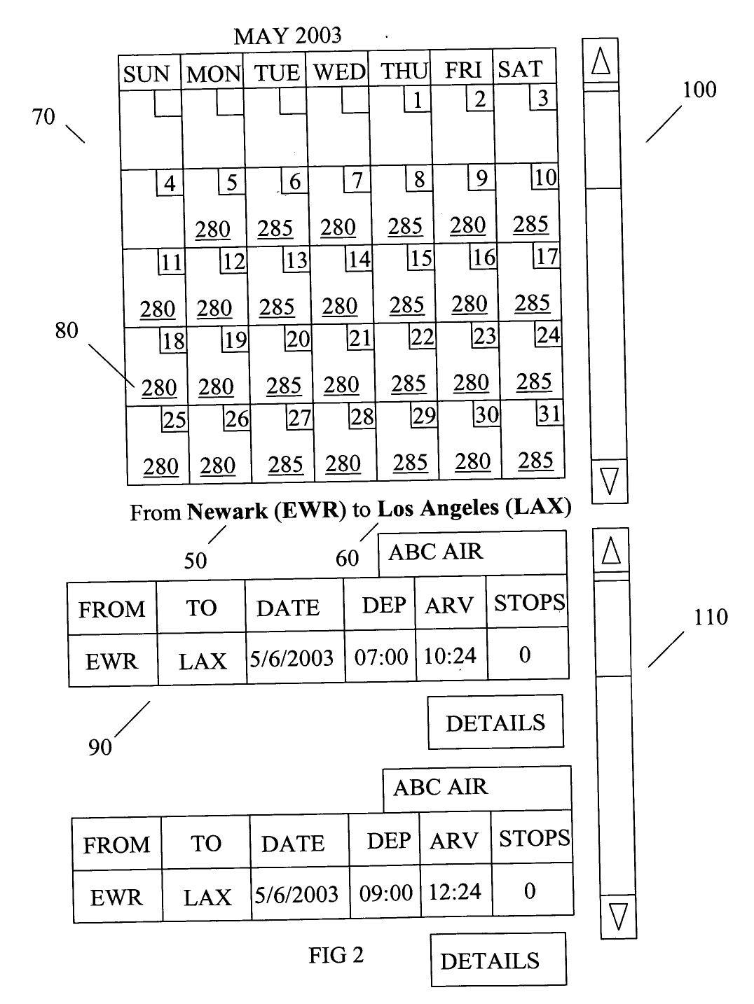

As seen from FIG. 1, the invention provides a network based system, such as a LAN (local area network), WAN (Wide Area Network), the Internet, or the like, wherein an operator accesses a display page (“home page”) that requires the operator to enter information into a city or airport (or some other geographic location) of origin field (“From” 10) and a destination city or airport (or some other geographic location) field (“To:” 20). Those skilled in the relevant art will recognize that the home page could be a different display page other than the display page shown in FIG. 1 which has a link to the display page of FIG. 1. If the operator of the system wants to enter the airport code, but does not know the specific airport code there is a link 200 which provides a list of various airports and their codes. This list could be stored on the system or accessed from a third party database. Once the operator enters the information into the two fields two options are provided (search flights 30 or search nearby 40). If the operator selects search flights 30 the system searches airfare information provided by the various airlines or by some other third party provider. The results are displayed on a new display page as illustrated by FIG. 2. Those skilled in the art will recognize that the results could alternatively be provided on the same page as the query and could include a ranking of the costs, such as multiple dollar signs or some other indication of ranking.

As seen from FIG. 2, the results of the search are displayed as a monthly calendar 70 with the lowest fare 80 displayed with the days of the month. The operator is provided the option of selecting a different month by using scroll bar 100. Alternatively, the operator could be provided a drop-down menu with a list of months to choose from. Currently, the system is set to allow 3 months to be displayed, however, this is merely a design choice and fewer or more months may be enabled. The use of a monthly calendar is also a design choice. It could be a weekly calendar, 2 week calendar, 2 month calendar, etc. Further, the operator could be provided with a choice of the time period to display. As also illustrated in FIG. 2, the results for a particular day are displayed alongside the calendar as a scrollable list 90. While FIG. 2 illustrates the list 90 on the side of the calendar 70, this too is a design choice. The list 90 could be displayed in a new window or could be displayed in a different part of the window. Different lists can be selected by simply selecting a particular day from the calendar. Another design choice is the fare listed in the calendar. Currently only the lowest price is displayed, however it could also be the highest price, the median price, an average price a combination of these prices, some other criterion based price etc.

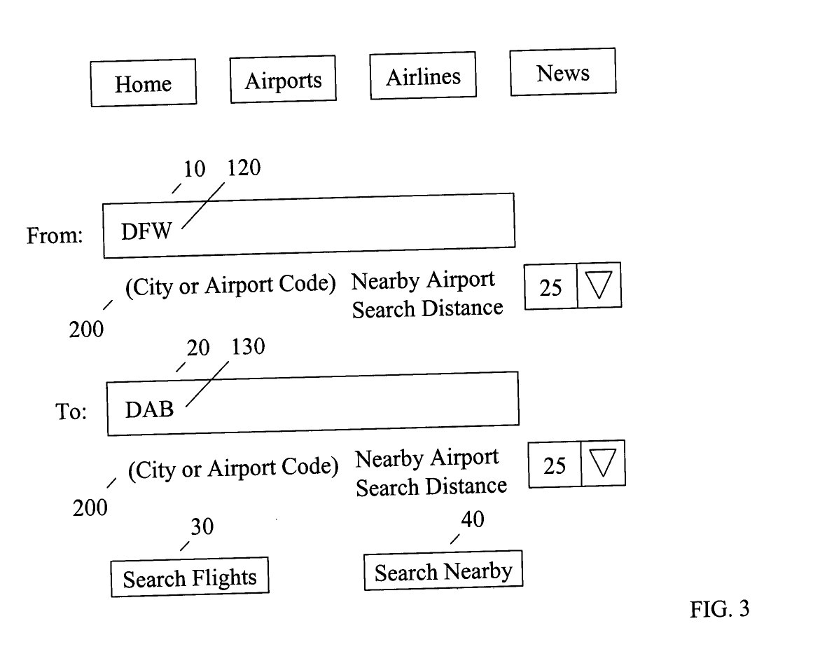

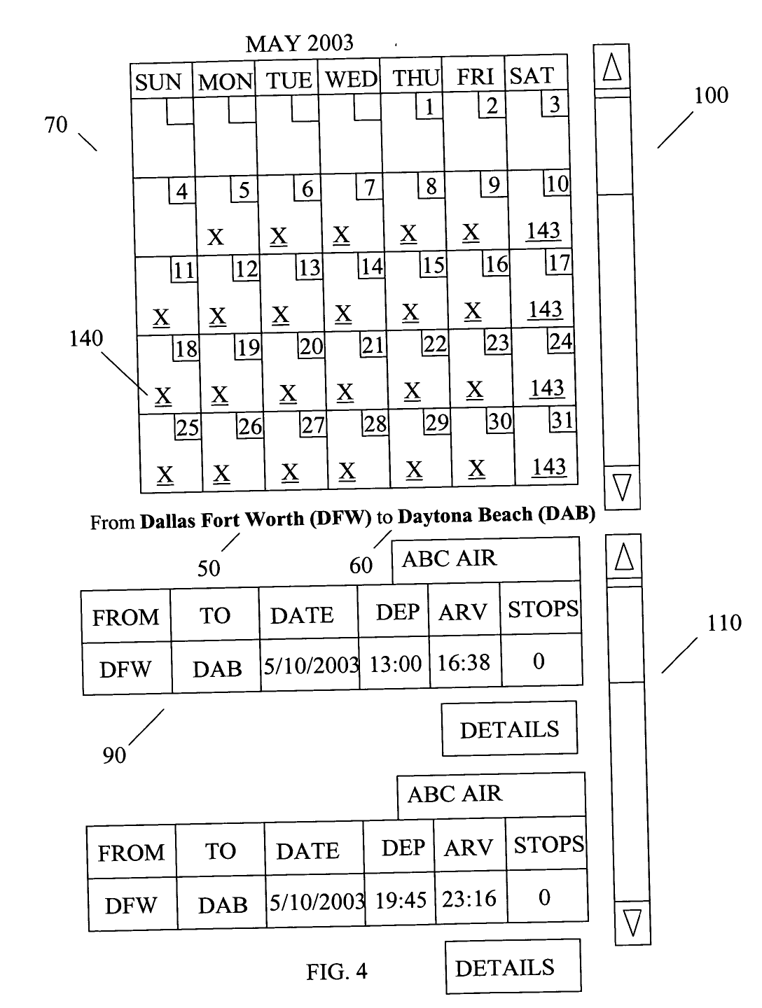

FIG. 3 illustrates the home page with two new locations entered into the To 20 and From 10 fields. These destinations were selected to illustrate what happens when there are days that no flights are available. As seen from the results of this search illustrated in FIG. 4, only certain days offer flights from this origin 10 to the destination 20. Accordingly, days that have no flights available are populated with an X 140. Those skilled in the art will recognize that these days could have been left blank, could be shaded with a particular color, a different character could have been selected or a combination thereof to represent no available flights.

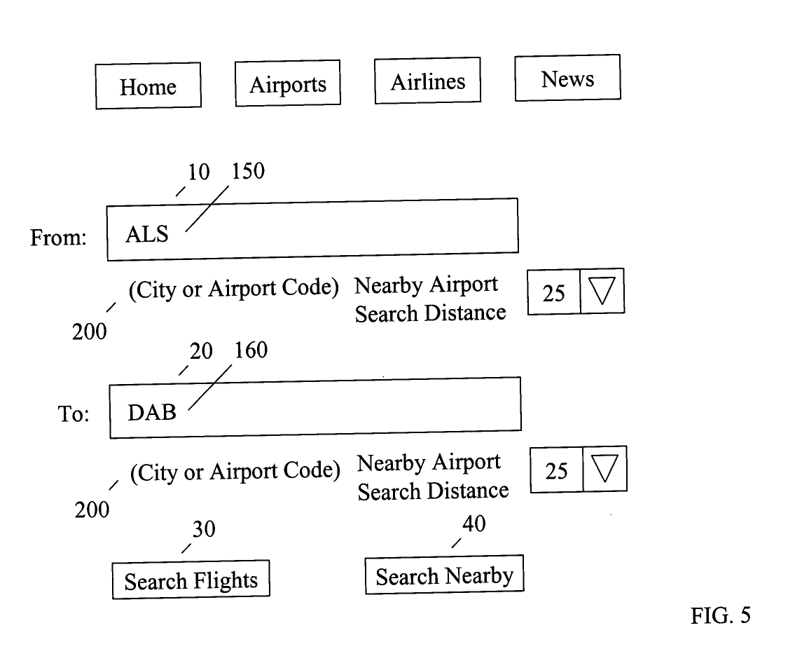

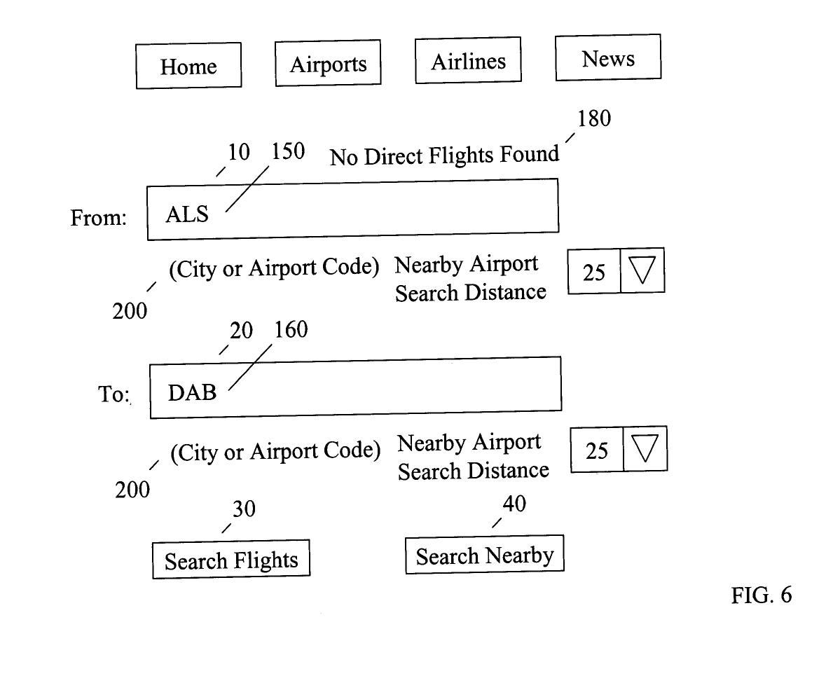

Finally, FIG. 5 illustrates the home page with two new locations entered into the To 20 and From 10 fields. These destinations were selected to illustrate what happens when there are no flights available. As seen from the results of this search illustrated in FIG. 6, the calendar is not displayed. Instead the display returns to the same page with a comment 180 that no direct flights are found. This is done for convenience to the operator since there is no need to change screens to enter new information or to search for nearby airports. However, it would not be outside the scope of the invention to provide either an empty calendar, a calendar filled with x's 140 or filled with some other character representing no flights, or a separate message screen indicating no flights and/or providing additional options.

The current form of the invention provides information about one way direct flights. However, it is within the scope of the invention that this can easily be adapted to include indirect flights and round trip flights.

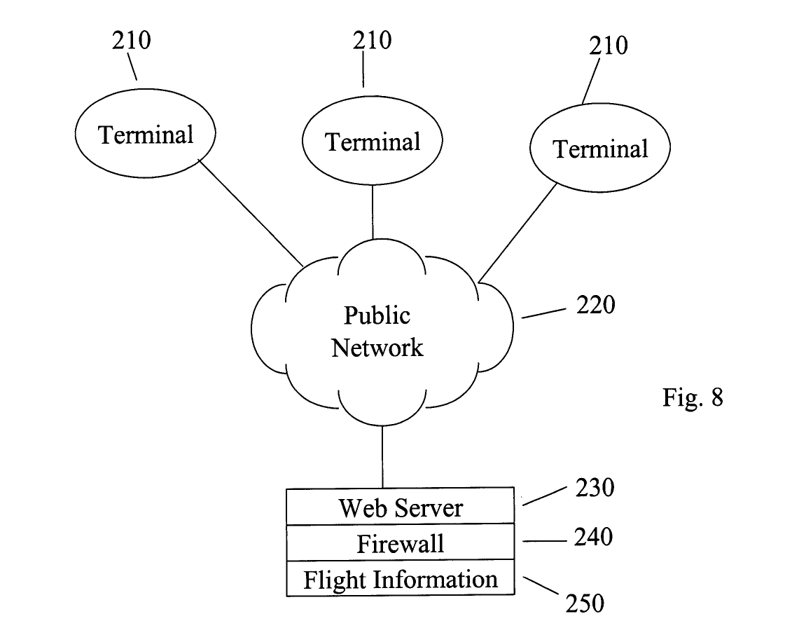

FIG. 8 illustrates a system in accordance with the present invention wherein one or more persons connects to the web site in a conventional manner (e.g. using a computer, PDA, a set top box etc.) Using the computer or the like 210, the person(s) navigate the Internet or some other network 220 to reach the web site. Once at the web site, the person(s) may have the option of browsing the site to determine how it operates, of signing in with a previously received username and password, of obtaining a new username and password or of retrieving a forgotten username and/or password. Those skilled in the art will recognize that the signing in process may be required to enter the site or to start a search, or may not be required at all. Further, the user name could be the person's actual name or a name chosen by the person or by the web site.

As also seen from FIG. 8, the system may include one or more servers which may be duplicative in function or which may provide different features. At least one of the servers could include one or more levels of security such as a firewall 240, passwords, encryption codes, etc. to prevent a user or some unscrupulous person from accidentally or purposely accessing information behind the firewall 240. Thus, the security could prevent an unauthorized party from tampering with the site. The server can maintain a database of flight information or could be configured to access one or more third party databases or the like to receive the desired information. The programming required to operate this site is fairly straightforward and thus does not require further explanation. Most programmers could design the site based upon the disclosure of this patent without undue experimentation.

It will be understood that changes may be made in the above construction and in the foregoing sequences of operation without departing from the scope of the invention. For instance, while the above description focuses mainly on air transportation, the same theory could be applied to rail, helicopter or boat travel as well. It is accordingly intended that all matter contained in the above description or shown in the accompanying drawings be interpreted as illustrative rather than in a limiting sense.

It is also to be understood that the following claims are intended to cover all of the generic and specific features of the invention as described herein, and all statements of the scope of the invention which, as a matter of language, might be said to fall therebetween. Having described the invention, what is claimed as new and secured by Letters Patent is:

What is claimed is:

1. A method of locating airfares comprising:
receiving at a search engine a starting location and an ending location;
determining flights scheduled to fly between the starting location and the ending location during a predetermined time period;
determining a cost for each of the determined flights;
displaying at least one of the costs in a calendar, wherein the calendar includes at least a portion of the predetermined time period.

2. The method according to claim 1 wherein the determined flights include direct flights.

3. The method according to claim 1 wherein the determined flights include multiple hop flights.

4. The method according to claim 1 wherein the calendar includes a monthly calendar.

5. The method according to claim 1 wherein the calendar includes a weekly calendar.

6. The method according to claim 1 wherein the calendar includes a daily calendar.

7. The method according to claim 1 wherein the displaying at least one of the costs includes displaying a plurality of costs.

8. The method according to claim 1 further comprising displaying a list of daily flights in response to a selection of a date in the calendar.

9. The method according to claim 8 further comprising displaying a list of flight details with the list of daily flights.

10. The method according to claim 1 further comprising displaying a list of flight details in response to a selection of a displayed cost.

11. The method according to claim 1 further comprising determining flights scheduled to fly from the ending location to the starting location during the predetermined time period;
determining a cost for at least one round trip flight and displaying said cost for said at least one round trip flight in the calendar.

12. The method according to claim 1 wherein it is determined that no direct flights are scheduled between the starting and ending locations on a particular day during the predetermined time period and providing an indication of the same in the calendar.

13. The method according to claim 1 wherein it is determined that no direct flights are scheduled between the starting and ending locations during the predetermined time period and providing an indication of the same.

14. The method according to claim 1 wherein the starting and ending locations include airport codes.

15. The method according to claim 1 wherein the starting and ending locations include cities.

16. The method according to claim 1 further comprising ranking the costs.

17. The method according to claim 1 further comprising providing a list of alternate locations.

18. A method of locating fares for travel comprising:
receiving at a search engine a starting location and an ending location;
determining scheduled routes between the starting location and the ending location during a predetermined time period;
determining a cost for each of the determined routes;
displaying at least one of the costs in a calendar, wherein the calendar includes at least a portion of the predetermined time period.

19. The method according to claim 16 wherein the travel comprises air travel.

20. The method according to claim 16 wherein the travel comprises rail travel.

21. The method according to claim 16 wherein the travel comprises boat travel.

22. A system for locating airfares comprising:
a computer, accessible from at lease one remote location, configured to display a starting location field and a destination field;
the computer being configured to determine flights, subsequent to the fields being populated, scheduled to fly between the starting location and the ending location during a predetermined time period;
the computer is also configured to determine a cost for each of the determined flights and to display at least one of the costs in a calendar, wherein the calendar includes at least a portion of the predetermined time period.
